(19) United States
(12) Patent Application Publication
(10) Pub. No.: US 2006/0052443 A1
(43) Pub. Date: Mar. 9, 2006

(54) Compositions and devices for prevention of termite, pest and fungi infestation

(76) Inventor: Victor Newman, San Francisco, CA (US)

Correspondence Address: QUINE INTELLECTUAL PROPERTY LAW GROUP, P.C., P O BOX 458, ALAMEDA, CA, 94501, US

(21) Appl. No.: 11/202,949

(22) Filed: Aug. 12, 2005

Related U.S. Application Data
(60) Provisional application No. 60/601,358, filed on Aug. 13, 2004.

(51) Int. Cl. A01N 53/00

(52) U.S. Cl. 514/531

(57) ABSTRACT

The invention provides compositions, devices, and methods for the control of Termites, General Pests and Fungi, such compositions and devices comprising one or more of Phenothrin, a Borate, and a Plant Oil or a derivative thereof.

### CROSS-REFERENCE TO RELATED APPLICATIONS

This application claims the benefit of U.S. Provisional Application No. 60/601,358 filed Aug. 13, 2004, entitled “Termite, pest and fungi prevention system/wood protection.” This prior application is hereby incorporated by reference in its entirety for all purposes.

### FIELD OF THE INVENTION

The present invention relates to the prevention of pests such as termites and fungi or other general pests inside and outside of homes and buildings.

### BACKGROUND OF THE INVENTION

In the United States control and damage repair costs due to Subterranean Termites (Reticulitermes ssp.) exceed $ 5 billion per year world wide (Su & Scheffrahn) and $2.5 billion in the U. S. and over $300 million in California a decade ago (Brier, Dost, & Wilcox 1988). Chemical barriers have been the dominant means of protecting the multi billion dollar national investment in the wood service for more than 50 years. Since the early 1940's when hydrocarbons were shown to have biological activity against insects, chemical barriers have been the mainstay of the pest control industry in combating termite and pest infestations. The risk homeowners face in having termite and pest infestation is substantial; 30% of all structural pest inspections reports (over 1.5 million conducted per year) reveal signs of active termites (Brier, Dost, & Wilcox 1988). Researchers predict almost 100% of untreated homes in regions of the country will eventually be infested with termites and or pests, according to a September 1999 workshop on termites sponsored by the (National Park Service in Louisiana) a state hard hit by the termite.

Other background insects include but not limited to are Ants which some are known to exist in cracks in concrete in large mounds several feet in height and from 12 to 18 inches in diameter if left undisturbed for a long period of time ants a social insect that live in well organized colonies. Nearly all of the ants in the colony are the wingless sterile females, called workers typically seen on and around the ant hill (Iowa St. Univ. Dept. of Entomology) like termites in the spring and fall ant colonies may produce winged males and females called swarmers. They disperse from well established nest to begin new colonies. Treatment for these areas onto the surface or drench the area with liquid pesticide is generally a common method of application. But this method is difficult for the cockroach, which has 47 species of the American Cockroach (Perplaneta Americana) alone, none of which are endemic to the U.S.(Bell and Adiyodi 1981) the American cockroach came to the United States from Africa as early as 1625 and resides indoors as well as outdoors. It is found mainly in basements, sewers, steam tunnels and drainage systems (Rust et. al 1991). This cockroach is readily found in commercial and large buildings such as restaurants, grocery stores, bakeries and where food is prepared and stored. Also in this background it would also refer to wood destroying fungus known in most circles as Dry Rot, decay fungi can cause severe structural damage to any wood member, even wood species such as redwood and cedar. All that is needed is a source of water in contact with the wood, decay will occur in untreated wood in direct contact with the ground, cement or concrete, or exposed to a source of moisture such as rain seepage, plumbing leaks or condensation. Wood kept dry will never decay! “Brown Rot” fungi feed on the wood's cellulose a component of the wood's cell wall, leaving a brown residue of lignin the substance which holds the cells together. Advanced infestations of brown rot are evidenced by wood more brown in color than normal, tending to crack across the grain eventually it will turn to powder when crushed. White Rot attacks wood, it breaks down both lignin and cellulose, white rot normally does not crack across the grain, gradually it will lose its strength and become spongy to the touch. Moisture content is the critical factor determining wood's susceptibility to decay. It must exceed 28% and liquid water must be present in all cell cavities before fungi can gain a toehold. This is one reason why framing lumber is dried to 19% moisture content or less.

Accordingly there is a need for novel compositions against termites, pests, and fungi and other wood destroying organisms, there is a need for a method of treating the structure and its surroundings to eliminate these types of pests. The present invention provides novel compositions and devices for control of various insect pests. The current invention also provides additional advantages which will be apparent upon reading of the description, claims, herein.

### BRIEF DESCRIPTION OF THE DRAWINGS

FIG. 1 displays the molecular structure of d-Phenothrin 3-phenoxybenzyl(1R)-cis, trans-chrysanthemate, an exemplary pesticide of the compositions of the invention.

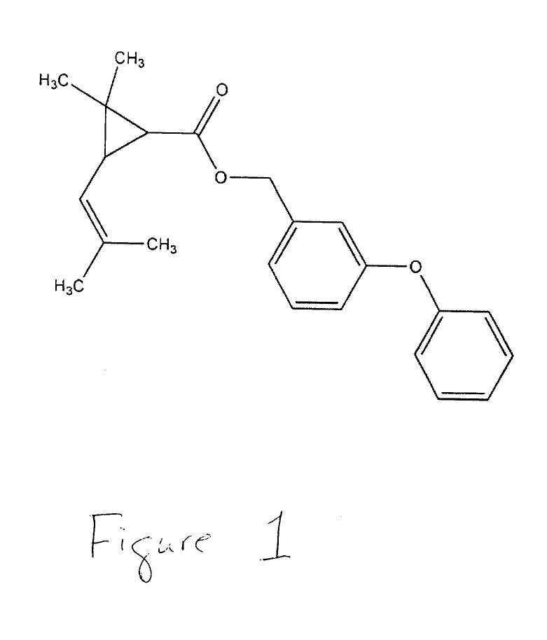

### SUMMARY OF THE INVENTION

The subject invention is based on the inventor's discovery that Phenothrin, Disodium Octaborate Tetrahydrate and N-(Hydroyethyl)amide, coconut, has a dramatic effect on termites, pests and fungi and the inventor has also found it to be lethal to these target pests. Other embodiments herein comprise chlorpyrifos and/or permethrin as the pesticide in the compositions, devices and methods.

Therefore, one aspect of the invention pertains to a novel composition comprising of Phenothrin (or optionally chlorpyrifos and/or permethrin), Disodium Octaborate Tetrahydrate and N-(Hydroxyethyl)amine, coconut in formulation for prevention and treatment of termites, pests and fungi infestations.

A further aspect of the subject invention relates to novel methods of preventing infestations of termites, pests and fungi with compositions that comprises Phenothrin (or optionally chlorpyrifos and/or permethrin), Disodium Octaborate Tetrahydrate and N-(Hydroxyethyl)amine, coconut on or near a structure desired to be protected. Those skilled in the art will realize that structures include, but not limited to posts, beams, boards, panels, sheets and wood or wood based material, as well as houses and buildings made of wood and wood based materials which can all be treated with the compositions and methods of the invention.

According to another aspect, the subject invention pertains to treating for termites, pests and fungi infestations. These and other features of the invention will become more fully apparent when the following detailed description is read in conjunction with the accompanying description and claims.

### DETAILED DESCRIPTION

Before describing the present invention in detail, it is to be understood that this invention is not limited to particular embodiments, which can, of course, vary. It is also to be understood that the terminology used herein is for the purpose of describing particular embodiments only, and is not necessarily intended to be limiting. As used in this specification and the appended claims, terms in the singular and the singular forms “a,” “an,” and “the” include plural referents unless the context clearly dictates otherwise. Thus, for example, reference to “a composition,” also includes a plurality of compositions, and the like.

The present invention comprises a compilation of chemicals used as an alternative to common termiticides, pesticides and fungicides. This compilation allows resistance to termites, wood boring beetles, carpenter ants and bees, fungi and other wood destroying organisms and general pests by treating the soil at the exterior and interior portions of the foundations and walls along with treating wood members and around plants. In addition it would be desirable to provide a barrier of protection under, around and on wood components of the structure both pre-construction and post-construction and to incorporate this with under the slab/foundation of the structure this would preserve the properties of the composition and minimize the environmental impact. This Invention is designed to have a longer residual life and doesn't require special equipment and is simple in its application. These ingredients consist of a Termite and Pest killer such as Phenothrin, Chlorpyrifos, Permethrin as an Active ingredient and yet while using a Borate as a dehydrate a Soy Bean Oil, Canola Oil and or Coconut Oil as a attractant these would be considered Inert ingredients. For example: when putting these ingredients together ¾ parts “termite/pest/fungi killer” 3/16 part borate and 1/16 soy/canola/coconut oil, when combining these entities together creates this invention. When these ingredients are in concentrated form and then mixed with water it is in the ideal form for treating the “target pest.” For example: use of a 0.5 to 1.0% emulsion for Termites. Mix 1-4 gallons of the mixture in 98 gallons of water for post-construction treatment by injection or horizontal spraying not exceeding 25-50 p.s.i. at the nozzle, this method of application is especially designed for “rodding and trenching” and also maybe used in a biodegradable form. When in its concentrate form in its professional usage it allows about 4 gallons of emulsion per 10 linear feet per foot of depth. In treating problem pests such as ants, spiders, and sow bugs. For example should be 20 p.s.i. or less when treating these type of insects and should be treated at the infested areas. Note: when treating such pests in areas like these the 0.25 to 0.5% emulsion should apply. To treat or protect against fungus or fungi for Example: can be treated with these entities with 0.25 to 0.5% emulsion spraying the untreated wood members with 20 p.s.i. or less at the nozzle, if the wood should have an existing infection all decay should be removed and the member would be treated to kill the existing spores and to protect the wood itself, all these above methods could and should be applied by professionals. This method of installation is common in most areas of the country. When in its biodegradable form it must be applied to the soil grade adjacent to the foundation wall and should be trenched about 6 to 8 inches in depth and about 6 to 8 inches in width then water is added a few gallons per foot of the Termite, Pest and Fungi/Tubular Prevention Composition or until foam emulsion is established, the soil is covered over the trenched area and the “Composition” allowing it to drain down into the soil and crystallize around the area treated creating a chemical barrier.

This method and or process may apply to treating around trees, planter boxes, planter boxes, porches and decks. This method of treatment does not require a special license but will require gloves and possible protective eyewear.

In various embodiments, the current invention comprises a termite/pest/fungi prevention system comprising: phenothrin, chlorpyrifos, and/or permethrin; a borate (e.g., sodium borate, disodium octaborate tetrahydrate); and an oil such as soybean, coconut or canola. Synonyms for coconut oil include, e.g., Amides, coco, N-(Hydroxyethyl); N-(Hydroxyethyl)amide, coconut. Such systems can comprise compositions of, e.g., 75% phenothrin, chlorpyrifos, and/or permethrin; 20% disodium octaborate tetrahydrate; and, 5% oil (e.g., soybean, coconut and/or canola). Other embodiments comprise compositions comprising 25% phenothrin, chlotpyrifos, and/or permethrin; 15% disodium octaborate tetrahydrate; and, 60% oil (e.g., soybean, coconut and/or canola). In other aspects the invention comprises methods of preventing termites, using such composition by obtaining a piece of wood to be treated, and treating the wood with such compositions. Such wood can be used in construction projects similar to untreated wood. Such wood can be treated with the compositions of the invention by spraying the wood (and/or other areas) with a high-pressure sprayer. The compositions of the invention can optionally be diluted prior to their use. For example, the compositions can be diluted to 0.5-1.0%, or by diluting 100-200 times the volume of the composition in water, etc. In other aspects, the invention comprises methods of protecting a building (exterior and/or interior and/or foundation) from pests by, identifying the building to be protected, preparing a composition of the invention, and treating the soil surrounding the foundation of the building with the composition. Other embodiments include, e.g., treating a piece of wood with compositions of the invention and using such treated wood in direct contact with soil, with soil infested with insects/fungi, etc,. in order to kill insects/fungi. Again, the compositions can be diluted prior to use in protection of buildings and the diluted compositions can be applied to the building and its surroundings via a high-pressure sprayer.

### EXAMPLE 1

The goal is to establish a continuous chemical barrier between the termite colony (usually in the soil) and wood in a building. Sometimes there may be a second termite colony above the soil (in the roof or other areas with a constant moisture supply) that requires additional treatment. Insecticide barriers may be established during or after building construction. In an existing building, termite treatments may involve any of the following procedures: a) mechanical alterations and/or b) use of an insecticide to treat the soil, foundation and wood. In most cases, it is beyond the ability of an untrained person to attempt the termite treatment, unless is a spot treatment or a person has work experience in this area.

### EXAMPLE 2

Generally termite treatment should be performed by professional pest control operators. Termite treatment requires special tool such as hammer drills, sub-slab injectors, rodding devices, engines equipped with pumps, protective equipment. These insecticide methods control termites, pests if applied properly.

### EXAMPLE 3

When the compound is in a tubular form of concentrate the component is “Bio degradable” like peat moss rolled in cellophane. This component can be applied by any homeowner as a “do-it-yourself installation and is placed in areas around the structure and foundation were trenching is performed and then the component is placed in the trench water is applied until emulsification then covered over with the trenched soil. This application is useful in the remediation of pests and termites.

References cited: 1514377 November 1924 Dow et al., pp. 514/730; Rust M K, Reierson D A, Hansgen K H. 1991 210-213; Bell W J, Adiyodi KG 1981 Chapman and Hall, London V. Lewis, M. Haverty, D. S. Carver and C. Fouche—Insecticide Barriers for Control of Reticulitermes ssp. (Isoptera: Rhinotermitidae) Div. of insect Biology, Dept. of Environmental Sciences, U.C. Berkeley,

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above may be used in various combinations. All publications, patents, patent applications, or other documents cited in this application are incorporated by reference in their entirety for all purposes to the same extent as if each individual publication, patent, patent application, or other document were individually indicated to be incorporated by reference for all purposes

What is claimed is:

1. A composition for prevention of termite, pest and/or fungi infestation, the composition comprising Phenothrin(3-phenoxybenzyl(1R)-cis trans-chrysanthemate), chlorpyrifos, and/or permethrin.

2. The composition of claim 1, further comprising a Disodium Octaborate Tetrahydrate.

3. The composition of claim 2 further comprising an oil attractant/emulsifier.

4. The composition of claim 3, wherein the attractant/emulsifier comprises N-(Hydroxyethyl)amide, coconut.

5. The composition of claim 3, wherein the recited ingredients are combined as 25% Phenothrin, chlorpyrifos or permethrin, 15% Disodium Octaborate Tetrahydrate, and 60% N-(Hydroxyethyl)amide, coconut.

6. The composition of claim 5 used as prevention in and around a structure.

7. A method of preventing termite, pest and/or fungi, the method comprising using a composition containing Phenothrin, chlorpyrifos, and/or permethrin, Disodium Octaborate Tetrahydrate, and N-(Hydroxyethyl)amide, coconut, the method comprising:
a. obtaining a piece of wood to be treated;
b. pre-treating and/or post-treating the wood with the composition.

8. The method of claim 7 wherein the step of treating the wood and other areas with the composition comprises spraying the composition onto the wood and other areas with a high-pressure sprayer.

9. The method of claim 7, wherein the steps recited are preceded by the steps of mixing the composition as 25% Phenothrin, chlorpyrifos, and/or permethrin; Disodium Octaborate Tetrahydrate; and N-(Hydroxyetyl)amine, coconut; and diluting the composition to 0.5-1% of its concentration.

10. A method of preventing termite, pest and fungi, the method comprising using a composition comprising Phenothrin, chlorpyrifos, and/or permethrin, Disodium Octaborate Tetrahydrate, and N-(Hydroxyethyl)amine, coconut, to protect a structure, exterior, interior portion and/or the foundation of the structure, the method comprising:
a. identifying a structure to be protected;
b. preparing the composition; and,
c. treating the soil surrounding the foundation of the structure with the composition.

11. The method of claim 10 wherein the step of preparing the composition further comprises: mixing the composition as 25% Phenothrin, chlorpyrifos, and/or permethrin, 15% Disodium Octaborate Tetrahydrate, and 60% N-(Hydroxyethl)amide, coconut.

12. The method of claim 11, further comprising diluting the composition in water; and treating the soil, foundations, walls, or other building components and/or surrounding areas, with the composition

13. The method of claim 12, further comprising spraying, applying and/or laying the composition onto a wall, soil and or mound treating both sides of the foundation and walls with a high-pressure spaying apparatus.

14. The method of claim 12 wherein the steps of preparing and diluting the composition in water comprises:
a. preparing a volume of composition; and
b. diluting the volume of the composition with water in an amount that substantially 100-200 times the volume of the composition.
